(19) United States
(12) Patent Application Publication
(10) Pub. No.: US 2011/0100006 A1
(43) Pub. Date: May 5, 2011

(54) INTEGRATED PROCESS FOR WATER-HYDROGEN-ELECTRICITY NUCLEAR GAS-COOLED REACTOR

(75) Inventors: Hee Cheon No, Daejeon (KR); Young-Soo Kim, Seoul (KR); Hosik Kim, Daejeon (KR); Ho Joon Yoon, Daejeon (KR); Hyung Gon Jin, Daejeon (KR); Byong Guk Jeon, Seoul (KR); Jinyoung Choi, Busan (KR); Jeong Ik Lee, Daejeon (KR)

(73) Assignee: KOREA ADVANCED INSTITUTE OF SCIENCE AND TECHNOLOGY, Daejon (KR)

(21) Appl. No.: 12/906,506

(22) Filed: Oct. 18, 2010

(30) Foreign Application Priority Data
Nov. 3, 2009 (KR) 10-2009-0105448

(51) Int. Cl. G21D 5/00

(52) U.S. Cl. 60/644.1

(57) ABSTRACT

Disclosed herein is an integrated process for production of electricity, hydrogen, and water using a high-temperature gas-cooled reactor as a single source, including: the high-temperature gas-cooled reactor, a power conversion unit connected directly or indirectly with the high-temperature gas-cooled reactor to receive heat produced by a reactor core of the high-temperature gas-cooled reactor and drive a gas turbine by the heat, thereby producing electricity through an electric generator, a hydrogen production unit that produces hydrogen by receiving the heat produced by the high-temperature gas-cooled reactor and/or the electricity produced by the electric generator, an electrical desalination unit that produces water by using the electricity produced by the electric generator, and a thermal desalination unit that produces water by distilling fresh water from salt water with waste heat recovered from a precooler and an intercooler of the power conversion unit.

### CROSS-REFERENCES TO RELATED APPLICATION

This patent application claims the benefit of priority under 35 U.S.C. §119 from Korean Patent Application No. 10-2009-0105448 filed Nov. 3, 2009, the contents of which are incorporated herein by reference.

### BACKGROUND OF THE INVENTION

1. Field of the Invention

The present disclosure relates to an integrated process for production of water, hydrogen, and electricity using a high-temperature gas-cooled reactor.

2. Description of the Related Art

As energy consumption rapidly increases worldwide, concerns about unstable price and exhaustion of fossil fuels are increasing and, accordingly, attentions are drawn to stable security of energy. Moreover, water-scarce regions are increasing throughout the globe due to abnormal climate of recent days. To this end, production of clean energy and water becomes essential for improvement of life quality of human beings, and various relevant technologies are shown up.

Especially, nuclear energy does not produce greenhouse gas and toxic gases such as CO₂, NOx, SOx, and so on and has a high efficiency enabling stable energy supply. Accordingly, the nuclear energy is being spotlighted as a promising clean energy source.

A high-temperature gas-cooled reactor (HTGR) is capable of supplying a high temperature heat source whereas it requires a relatively smaller plant in comparison with general nuclear power plants. In addition, since the HTGR has passive safety features in removing decay heat in case of an accident, the HTGR may be widely used from production of electricity to production of hydrogen through decomposition of water.

Hydrogen energy can be produced by decomposing water into oxygen and hydrogen with energy supplied from a reactor, thereby producing a large amount of hydrogen. Generally, for this, studies are in progress on a thermo-chemical process, an electrolysis process, a hybrid process combining the above processes, a high-temperature steam electrolysis process that produces hydrogen by generating steam by high-temperature heat and electrolyzing the steam, and so forth.

Especially, an iodine-sulfur cycle (IS cycle) among the thermo-chemical processes is known as the most prospective hydrogen production process. The IS cycle has actively been studied in the U.S., Korea, Japan, France, Italy, and so on since first introduced by General Atomics (GA) of the U.S. in early 1980s. The IS cycle includes three processes, that is, a Bunsen reaction process, a H₂SO₄ decomposition process, and a hydrogen iodide (HI) decomposition process. According to the IS cycle, water (H₂O) is decomposed by high heat of about 950° C. supplied from a high-temperature gas reactor, thereby producing hydrogen (H₂) and oxygen (O₂).

However, the IS cycle of GA has some limits. An efficiency of the Bunsen reaction process is limited due to an azeotropic point of the HI. In addition, the combination of high-temperature high-pressure operating condition and strong acid reactants are very corrosive to structural materials. Therefore, high-temperature low-pressure conditions are preferred to prevent corrosion of structural materials. However, operating under the high-temperature lower-pressure conditions is restricted in practice due to difficulties in safety and economy caused by a differential pressure between the reactor side and hydrogen side. Accordingly, solutions to overcome the difficulties are necessary.

Besides, the Hybrid Sulfur thermo-chemical process of Westinghouse in late 1970s produces hydrogen by electrolyzing sulphuric acid and decomposes SO₃ into SO₂ and O₂ through a thermo-chemical process.

The desalination market is increasing by growing 16.6% every year. Various large-scale desalination plants are being constructed to meet demands increasing due to climate change and desertification.

In general, desalination methods using distillation of water, such as a multi-stage flash distillation (MSF) process and a multiple effect distillation (MED) process, are used in desalination facilities. Although high-purity water can be obtained through the above methods, those methods require large energy consumption. In addition, there are a reverse osmosis (RO) process and a forward osmosis (FO) process, which are membrane processes. When the RO and the FO processes are used, less energy is consumed compared to the distillation process. However, maintenance and repair costs increase due to periodic washing and replacement of a filter and a permeable membrane. Furthermore, a hybrid process may be used to increase the fresh water productivity. The hybrid process is suggested by Doosan Heavy Industries and Construction as disclosed in Korean Patent Laid-open No. 2009-0067902.

Recently, studies are actively performed to commercialize a capacitive deionization (CDI) process which performs desalination through electrical adsorption by using a super capacitor.

As above mentioned, electricity, hydrogen, fresh water production processes are being studied, and those processes are separately performed according to related arts. Therefore, efficiency in use of the heat source is low.

To solve such waste of the heat source, U.S. Patent Laid-open No. 2004/0237526 shown in FIG. 1 introduces an L&N cycle capable of producing hydrogen, electricity, and water simultaneously by 1) a chemo-thermal process to convert water into oxygen and hydrogen, 2) a modified Regenerative Brayton cycle to produce electricity, 3) a thermal flash distillation desalination cycle, 4) an RO desalination cycle, and 5) an ion-exchange mineral extraction system. However, the above system chemo-thermally decomposes water into hydrogen and oxygen using a high-temperature heat source and then uses the high-temperature hydrogen and oxygen as a working fluid for production of water and electricity. That is, the heat source is intensively used for production of hydrogen.

To this end, the present inventors have studied to simultaneously produce electricity, water, and hydrogen, which are essential for life, using a single heat source, and to optimize the production ratio among the respective processes according to users' demands. As a result, there is devised an integrated system capable of producing electricity, hydrogen, and water simultaneously by supplying heat energy generated from a high-temperature gas-cooled reactor to a power conversion unit, a hydrogen production unit, and a desalination unit, and also capable of adjusting the production ratio of electricity, hydrogen, and water according to users' demands, which will be introduced as embodiments of the present invention.

### SUMMARY OF THE INVENTION

Embodiments of the present invention are directed to provide an integrated process for production of water, hydrogen, and electricity by using a high-temperature gas-cooled reactor (HTGR) as a single heat source.

According to an aspect of the present invention, there is provided an integrated process for production of electricity, hydrogen, and water using a high-temperature gas-cooled reactor, comprising the high-temperature gas-cooled reactor that produces a high-temperature heat source by using helium (He) as a working fluid, a power conversion unit connected directly or indirectly with the high-temperature gas-cooled reactor to receive heat produced by a reactor core of the high-temperature gas-cooled reactor and drive a gas turbine by the heat, thereby producing electricity through an electric generator, a hydrogen production unit that produces hydrogen by receiving the heat produced by the high-temperature gas-cooled reactor and/or the electricity produced by the electric generator, an electrical desalination unit that produces water by using the electricity produced by the electric generator, and a thermal desalination unit that produces water by distilling fresh water from salt water with waste heat recovered from a precooler and an intercooler of the power conversion unit.

As described above, the present invention has an effect of adjusting production quantities of electricity, hydrogen, and water according to users' demands and considerably increasing heat utilization rate by using a single heat source for multiple purposes.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating an L&N cycle that produces hydrogen, electricity, and water according to a related art;

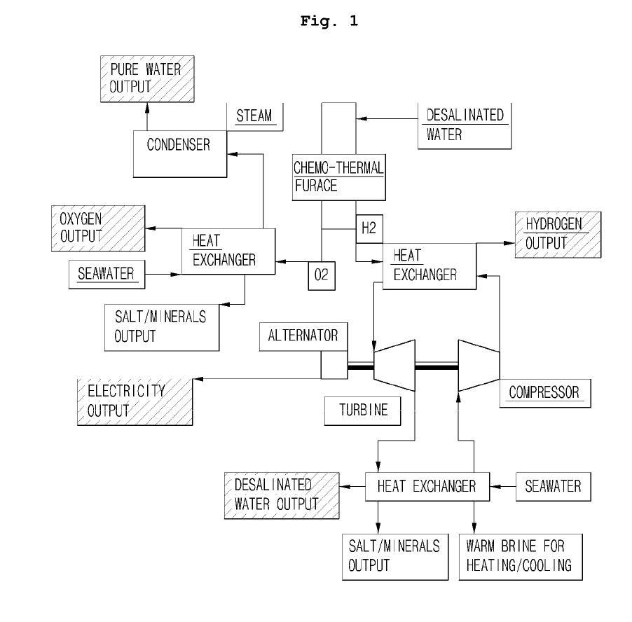

FIG. 2 is a diagram illustrating an integrated process for water, hydrogen, and electricity using a high temperature gas-cooled nuclear reactor as a single heat source according to an embodiment of the present invention;

FIG. 3 is a diagram illustrating an integrated process for water, hydrogen, and electricity using a high temperature gas-cooled nuclear reactor as a single heat source according to another embodiment of the present invention;

FIG. 4 is a diagram illustrating an integrated process for electricity and hydrogen using a high temperature gas-cooled reactor as a single heat source according to an embodiment of the present invention;

FIG. 5 is a diagram illustrating an integrated process for electricity and hydrogen using a high temperature gas-cooled nuclear reactor as a single heat source according to another embodiment of the present invention;

FIG. 6 is a diagram illustrating an integrated process for electricity and water using a high temperature gas-cooled nuclear reactor as a single heat source according to an embodiment of the present invention; and

FIG. 7 is a diagram illustrating an integrated process for electricity and water using a high temperature gas-cooled nuclear reactor as a single heat source according to another embodiment of the present invention.

### BRIEF DESCRIPTION OF THE MARK OF DRAWINGS

10: He
15: He, CO₂, N₂ or Gas Mixture
20: First Working Fluid
30: Fresh Water
40: Salt Water
50: H₂
60: O₂
70: Electricity
80: Second Working Fluid
90: Cooling Water
100: High Temperature Gas-cooled Reactor
110: First Intermediate Heat Exchanger
120: Second Intermediate Heat Exchanger
200: Power Conversion Unit
210: Gas Turbine
220: Recuperator
230: Precooler
240: Low Pressure Compressor
250: Intercooler
260: High Pressure Compressor
270: Electric Generator
300: Hydrogen Production Unit
310: Hydrogen Storage
320: Oxygen Storage
400: Electrical Desalination Unit
410: Thermal Desalination Unit
420: Salt Water Storage
430: Fresh Water Storage

### DESCRIPTION OF THE PREFERRED EMBODIMENTS

Features and advantages of the present invention will be more clearly understood by the following detailed description of the present preferred embodiments by reference to the accompanying drawings. It is first noted that terms or words used herein should be construed as meanings or concepts corresponding with the technical sprit of the present invention, based on the principle that the inventor can appropriately define the concepts of the terms to best describe his own invention. Also, it should be understood that detailed descriptions of well-known functions and structures related to the present invention will be omitted so as not to unnecessarily obscure the important point of the present invention.

Hereinafter, the embodiments of the present invention will be described with reference to the accompanying drawings.

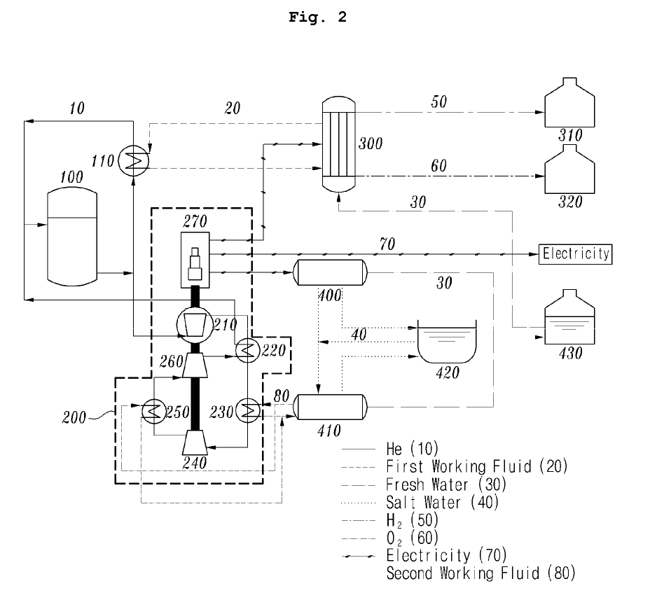

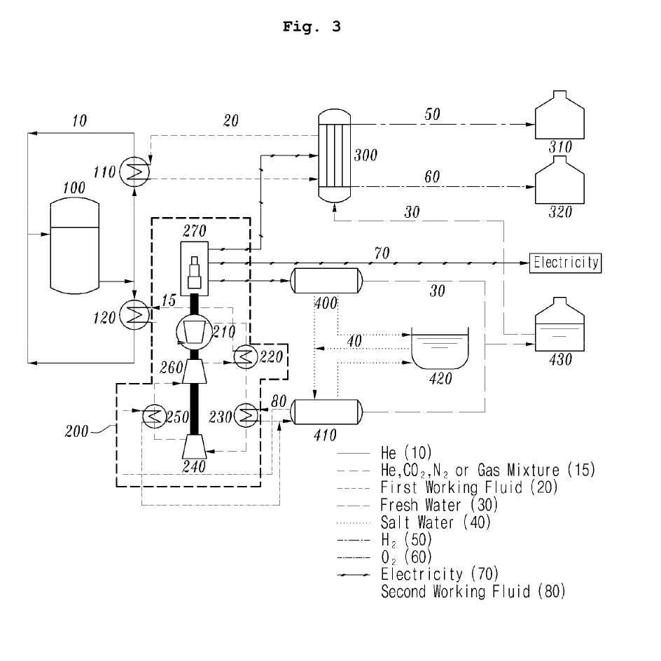

FIGS. 2 and 3 show an integrated process for electricity, hydrogen, and fresh water (hereinafter, referred merely as ‘water’) according to one embodiment of the present invention.

As shown in FIGS. 2 and 3, the integrated process is achieved by a high temperature gas cooled reactor 100 that produces a high-temperature heat source by using helium (He) 10 as a working fluid, a power conversion unit 200 connected directly or indirectly with the high-temperature gas-cooled reactor 100 to receive heat produced by a reactor core of the high-temperature gas-cooled reactor 100 and drive a gas turbine 210 by the heat, thereby producing electricity 70 through an electric generator 270, a hydrogen production unit 300 that produces hydrogen 50 by receiving the heat produced by the high-temperature gas-cooled reactor 100 and/or the electricity 70 produced by the electric generator 270, an electrical desalination unit 400 that produces water 30 using the electricity 70 produced by the electric generator 270, and a thermal desalination unit 410 that produces water by distilling water from salt water with waste heat recovered from a precooler 230 and an intercooler 250 of the power conversion unit 200.

The power conversion unit 200 includes the gas turbine 210, a recuperator 220, the precooler 230, a low pressure compressor 240, the intercooler 250, a high pressure compressor 260, and the electric generator 270. The power conversion unit 200 produces electricity through the electric generator 270 by operating the gas turbine 210 by receiving heat produced by the high-temperature gas-cooled reactor 100. Here, the power conversion unit 200 may use a direct cycle (see FIG. 2) that directly uses the working fluid of the high-temperature gas-cooled reactor 100 as a working fluid of the power conversion unit 200, or an indirect cycle (see FIG. 3) that transfers heat produced by the high-temperature gas-cooled reactor 100 to the power conversion unit 200 through a second intermediate heat exchanger 120 and uses He, CO₂, N₂, or a mixture of them 15 as a working fluid of the power conversion unit 200. The electricity produced by the electric generator 270 may be supplied to each home, or transferred to the desalination unit and/or the hydrogen production unit 300 to be used for production of water and/or hydrogen.

The hydrogen production unit 300 produces hydrogen by receiving heat produced by the high-temperature gas-cooled reactor through a first intermediate heat exchanger 110 or receiving the electricity generated from the electric generator 270. The hydrogen production unit 300 may produce hydrogen by a thermo-chemical process, an electrolysis process, a hybrid process, a high-temperature steam electrolysis process, and so forth although not limited thereto. Hydrogen and oxygen are produced as the water is decomposed in the hydrogen production unit 300. The hydrogen is transferred to a hydrogen storage 310 and the oxygen is transferred to an oxygen storage 320.

The desalination unit includes the electrical desalination unit 400 that produces water from salt water by using the electricity produced by the electric generator 270, and the thermal desalination unit 410 that produces water by recovering waste heat from the precooler 230 and the intercooler 250, evaporating water from salt water by the waste heat, and then condensing steam.

The electrical desalination unit 400 may produce water by a reverse osmosis (RO) process, a forward osmosis (FO) process, a capacitive deionization (CDI) process, and so forth. The thermal desalination unit 410 may produce water by a multi-stage flash distillation (MSF) process, a multiple effect distillation (MED), and so forth. However, the water production processes are not limited thereto.

The water produced by the desalination unit may be transferred to a water storage 430 to be used for production of hydrogen.

Concerning the integrated process for generation of electricity, hydrogen, and water according to the embodiment of the present invention, since the power conversion unit, the hydrogen production unit, and the desalination unit are integrated into a single system, production quantities of electricity, hydrogen, and water may be optimally adjusted according to users' demands.

According to a first method for this, when the He which flows from the high-temperature gas-cooled reactor 100 is moving to the first intermediate heat exchanger 110 for production of hydrogen, or is moving to the gas turbine 210 (FIG. 2) or the second intermediate heat exchanger 120 (FIG. 3) for production of electricity and water, a flow rate ratio of He is increased to a process requiring a higher production quantity. Thus, the production quantities of the electricity, hydrogen, and water may be adjusted as demanded.

According to a second method, the electricity 70 produced by the electric generator 270 is supplied back to the hydrogen production unit 300 or the electrical desalination unit 400 and used for production of hydrogen or water. Accordingly, the production quantities may be adjusted as demanded.

For example, in an area where demand for water is higher than for electricity and hydrogen, the He 10 which flows from the high-temperature gas-cooled reactor 100 is supplied more to the gas turbine 210 (FIG. 2) or the second intermediate heat exchanger 120 (FIG. 3) for production of electricity and water than to the first intermediate heat exchanger 110 for production of hydrogen. In addition, the electricity produced by the electric generator 270 is mainly used for the desalination unit. Accordingly, users' demands can be met.

Furthermore, the integrated process for electricity, hydrogen, and water according to the embodiment of the present invention is capable of storing surplus energy.

More specifically, considering that the power conversion unit, the hydrogen production unit, and the desalination unit are integrated into the single system according to the integrated process, during the time such as night or weekends when demand for electricity or water is relatively low, the He 10 which flows from the high-temperature gas-cooled reactor 100 may be mostly supplied to the first intermediate heat exchanger 110 for production of hydrogen so that the surplus energy (heat energy) may be stored in the form of hydrogen energy.

In addition, since the integrated process according to the embodiment of the present invention uses one heat source for multiple purposes, inefficient use of heat, that may be caused when electricity, hydrogen, and water production processes are all separated, is minimized. That is, heat utilization rate can be considerably increased.

Also, the integrated process according to the embodiment of the present invention may be altered to an integrated process for production of electricity and hydrogen or an integrated process for production of electricity and water.

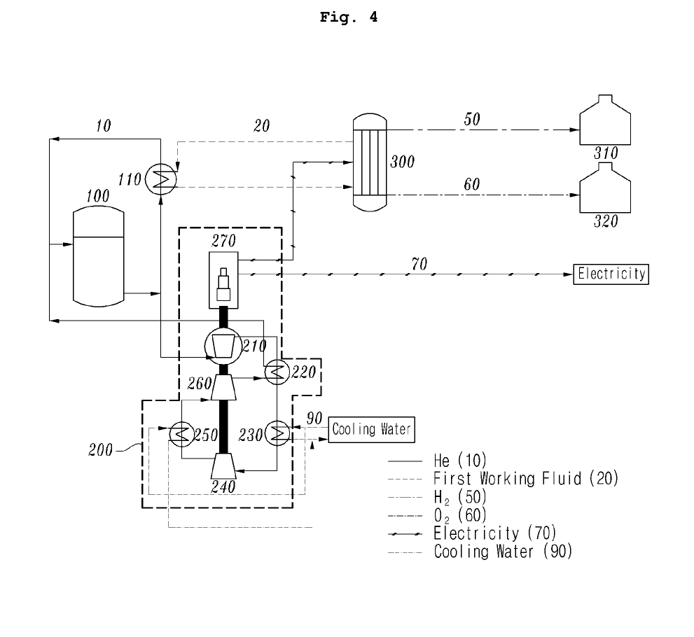

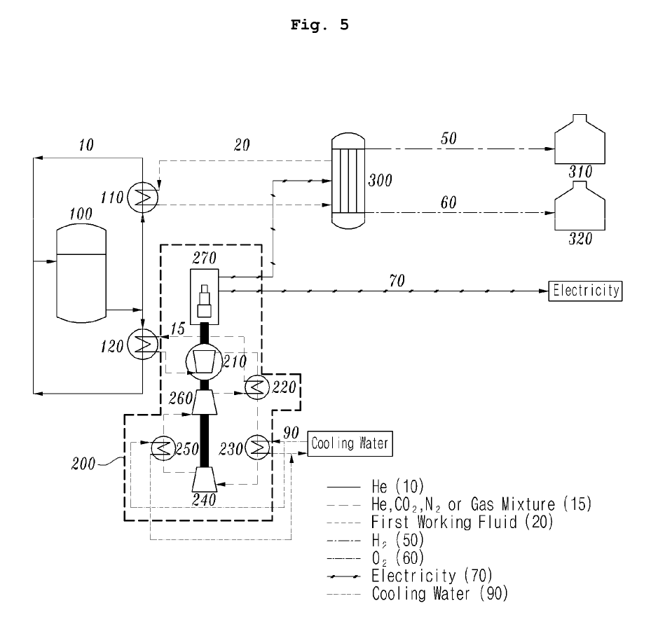

The integrated process for electricity and hydrogen according to one embodiment of, as shown in FIGS. 4 and 5, is achieved by the high-temperature gas-cooled reactor 100 that produces a high-temperature heat source by using the He 10 as a working fluid, the power conversion unit 200 connected directly or indirectly with the high-temperature gas-cooled reactor 100 to receive heat produced by the reactor core of the high-temperature gas-cooled reactor 100 and drive the gas turbine 210 by the heat, thereby producing the electricity 70 through the electric generator 270, the hydrogen production unit 300 that produces the hydrogen 50 by receiving heat produced by the high-temperature gas-cooled reactor 100 and/or the electricity 70 produced by the electric generator 270.

The power conversion unit 200 includes the gas turbine 210, the recuperator 220, the precooler 230, the low pressure compressor 240, the intercooler 250, the high pressure compressor 260, and the electric generator 270. The power conversion unit 200 generates electricity through the electric generator 270 by operating the gas turbine 210 by receiving heat produced by the high-temperature gas-cooled reactor 100. Here, the power conversion unit 200 may use a direct cycle (see FIG. 4) that directly uses the working fluid of the high-temperature gas-cooled reactor 100 as a working fluid of the power conversion unit 200, or an indirect cycle (see FIG. 5) that transfers heat produced by the high-temperature gas-cooled reactor 100 to the power conversion unit 200 through the second intermediate heat exchanger 120 and uses He, CO₂, N₂, or a mixture of them 15 as a working fluid of the power conversion unit 200. The electricity produced by the electric generator 270 may be supplied to each home, or transferred to the hydrogen production unit 300 to be used for production of hydrogen.

The hydrogen production unit 300 produces hydrogen by receiving the heat produced by the high-temperature gas-cooled reactor 100 through the first intermediate heat exchanger 110 or receiving the electricity produced by the electric generator 270. The hydrogen production unit 300 may produce hydrogen by the thermo-chemical process, the electrolysis process, the hybrid process, the high-temperature steam electrolysis process, and so forth although not limited thereto. Hydrogen and oxygen are produced as the water is decomposed in the hydrogen production unit 300. The hydrogen is transferred to the hydrogen storage 310 and the oxygen is transferred to the oxygen storage 320.

According to the above process, production ratio between the electricity and the hydrogen may be optimally adjusted according to users' demands. Also, surplus energy may be stored in the form of the hydrogen energy at night or on weekends when the demand for electricity is relatively low. Moreover, since one heat source is utilized for multiple purposes, inefficient use of heat, that may be caused when electricity and hydrogen production processes are all separated, is minimized. That is, heat utilization rate can be considerably increased.

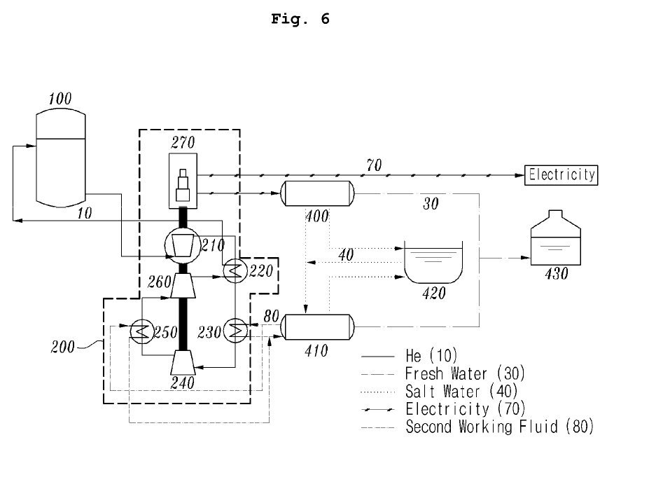

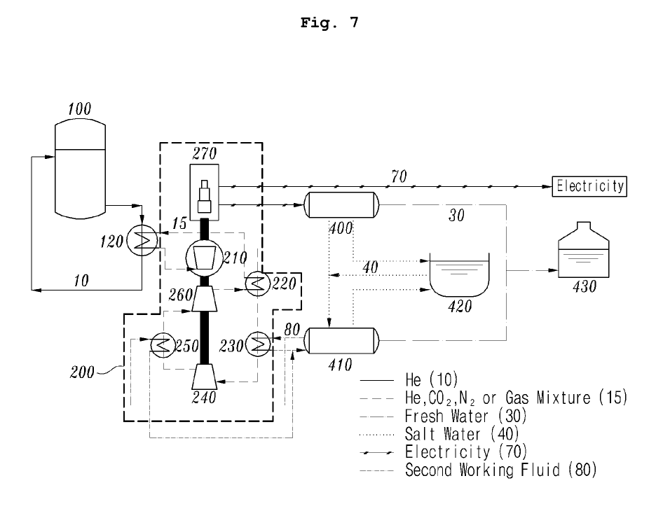

The integrated process for production of electricity and water, according to an embodiment of the present invention as shown in FIGS. 6 and 7, may be achieved by the high-temperature gas-cooled reactor 100 that produces a high-temperature heat source by using the He 10 as a working fluid, the power conversion unit 200 connected directly or indirectly with the high-temperature gas-cooled reactor 100 to receive heat produced by the reactor core of the high-temperature gas-cooled reactor 100 and drive the gas turbine 210 by the heat, thereby producing the electricity 70 through the electric generator 270, the electrical desalination unit 400 that produces the water 30 using the electricity 70 produced by the electric generator 270, and the thermal desalination unit 410 that produces water by distilling water from salt water with waste heat recovered from the precooler 230 and the intercooler 250 of the power conversion unit 200.

The power conversion unit 200 includes the gas turbine 210, the recuperator 220, the precooler 230, the low pressure compressor 240, the intercooler 250, the high pressure compressor 260, and the electric generator 270. The power conversion unit 200 generates electricity through the electric generator 270 by operating the gas turbine 210 by receiving heat produced by the high-temperature gas-cooled reactor 100. Here, the power conversion unit 200 may use a direct cycle (see FIG. 6) that directly uses the working fluid of the high-temperature gas-cooled reactor 100 as a working fluid of the power conversion unit 200, or an indirect cycle (see FIG. 7) that transfers heat produced by the high-temperature gas-cooled reactor 100 to the power conversion unit 200 through the second intermediate heat exchanger 120 and uses He, CO₂, N₂, or a mixture of them 15 as a working fluid of the power conversion unit 200. The electricity produced by the electric generator 270 may be supplied to each home, or transferred to the desalination unit to be used for production of water.

The desalination unit includes the electrical desalination unit 400 that produces water from salt water by using the electricity produced by the electric generator 270, and the thermal desalination unit 410 that produces water by recovering waste heat from the precooler 230 and the intercooler 250, evaporating water from salt water by the waste heat, and then condensing steam.

The electrical desalination unit 400 may produce water by the RO process, the FO process, the CDI process, and so forth. The thermal desalination unit 410 may produce water by the MSF process, the MED, and so forth. However, the water production processes are not limited thereto.

The water produced by the desalination unit is transferred to the water storage 430.

According to the above-introduced processes, production quantities of electricity and water can be adjusted to optimal conditions. When demand for electricity is relatively low, for example at night or on weekends, surplus electricity may be used for production of water, thereby increasing the utilization. Moreover, since one heat source is used for multiple purposes, inefficient use of heat, that may be caused when electricity, hydrogen, and water production processes are all separated, is minimized. That is, heat utilization rate can be considerably increased.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An integrated process for production of electricity, hydrogen, and water using a high-temperature gas-cooled reactor as a single source, comprising:
the high-temperature gas-cooled reactor that produces a high-temperature heat source by using helium (He) as a working fluid;
a power conversion unit that generates electricity through an electric generator by directly receiving heat produced by a reactor core of the high-temperature gas-cooled reactor in direct connection with the high-temperature gas-cooled reactor or indirectly receiving heat produced by the high-temperature gas-cooled reactor through an intermediate heat exchanger and a working fluid comprising He, CO₂, N₂, or a mixture of those gases and thereby driving a gas turbine by the heat;
a hydrogen production unit that produces hydrogen by receiving the heat produced by the high-temperature gas-cooled reactor and/or the electricity produced by the electric generator;
an electrical desalination unit that produces water using electricity produced by the electric generator; and
a thermal desalination unit that produces water by distilling water from salt water with waste heat recovered from a precooler and an intercooler of the power conversion unit.

2. The integrated process as set forth in claim 1, wherein the hydrogen production unit produces hydrogen by receiving water produced by the desalination unit and decomposing the water.

3. The integrated process as set forth in claim 1, wherein the hydrogen production unit produces hydrogen by a thermo-chemical process, an electrolysis process, a hybrid process, or a high-temperature steam electrolysis process.

4. The integrated process as set forth in claim 1, wherein the electrical desalination unit produces water by a reverse osmosis (RO) process, a forward osmosis (FO) process, or a capacitive deionization (CDI) process.

5. The integrated process as set forth in claim 1, wherein the thermal desalination unit produces water by a multi-stage flash distillation (MSF) process or a multiple effect distillation (MED) process.

6. The integrated process as set forth in claim 1, wherein the integrate process is capable of adjusting production quantities of electricity, hydrogen, and water according to users' demands by increasing a flow rate ratio of the He which flows from the high-temperature gas-cooled reactor to the one which requires a higher production quantity between the two: the hydrogen production unit and the power conversion unit which is coupled with the thermal desalination unit, or by supplying the electricity produced by the electric generator to the hydrogen production unit or the electrical desalination unit so that the electricity is used for production of hydrogen or water.

7. The integrated process as set forth in claim 1, wherein the He which flows from the high-temperature gas-cooled reactor is mostly supplied to the hydrogen production unit when demand for electricity or water reduces so that surplus energy is stored in the form of hydrogen energy.

8. The integrated process as set forth in claim 1, wherein, since a single heat source is used for multiple purposes, heat utilization rate is increased in comparison to when electricity, hydrogen, and water production processes are all separated and heat sources are separately used for the respective processes.

9. An integrated process for production of electricity and hydrogen using a high-temperature gas-cooled reactor as a single heat source, comprising:
the high-temperature gas-cooled reactor that produces a high-temperature heat source by using He as a working fluid;
a power conversion unit that generates electricity through an electric generator by directly receiving heat produced by a reactor core of the high-temperature gas-cooled reactor in direct connection with the high-temperature gas-cooled reactor or indirectly receiving heat produced by the high-temperature gas-cooled reactor through an intermediate heat exchanger and a working fluid comprising He, CO₂, N₂, or a mixture of those gases and thereby driving a gas turbine by the heat; and
a hydrogen production unit that produces hydrogen by receiving the heat produced by the high-temperature gas-cooled reactor and/or the electricity produced by the electric generator.

10. The integrated process as set forth in claim 9, wherein the hydrogen production unit produces hydrogen by a thermo-chemical process, an electrolysis process, a hybrid process, or a high-temperature steam electrolysis process.

11. The integrated process as set forth in claim 9, wherein the integrate process is capable of adjusting production quantities of electricity and hydrogen according to users' demands by increasing a flow rate ratio of the He which flows from the high-temperature gas-cooled reactor to the one which requires a higher production quantity between the two: the hydrogen production unit and the power conversion unit, or by supplying the electricity produced by the electric generator to the hydrogen production unit so that the electricity is used for production of hydrogen.

12. The integrated process as set forth in claim 9, wherein the He which flows from the high-temperature gas-cooled reactor is mostly supplied to the hydrogen production unit when demand for electricity reduces so that surplus energy is stored in the form of hydrogen energy.

13. The integrated process as set forth in claim 9, wherein, since a single heat source is used for multiple purposes, heat utilization rate is increased in comparison to when electricity and hydrogen production processes are separated and heat sources are separately used for the respective processes.

14. An integrated process for production of electricity and water using a high-temperature gas-cooled reactor as a single heat source, comprising:
the high-temperature gas-cooled reactor that produces a high-temperature heat source by using He as a working fluid;
a power conversion unit that generates electricity through an electric generator by directly receiving heat produced by a reactor core of the high-temperature gas-cooled reactor in direct connection with the high-temperature gas-cooled reactor or indirectly receiving heat produced by the high-temperature gas-cooled reactor through an intermediate heat exchanger and a working fluid comprising He, CO₂, N₂, or a mixture of those gases and thereby driving a gas turbine by the heat;
an electrical desalination unit that produces water using electricity produced by the electric generator; and
a thermal desalination unit that produces water by distilling water from salt water with waste heat recovered from a precooler and an intercooler of the power conversion unit.

15. The integrated process as set forth in claim 14, wherein the electrical desalination unit produces water by a RO process, a FO process, or a CDI process.

16. The integrated process as set forth in claim 14, wherein the thermal desalination unit produces water by a MSF process or a MED process.

17. The integrated process as set forth in claim 14, wherein the integrate process is capable of adjusting production quantities of electricity and water according to users' demands by supplying the electricity produced by the electric generator to the electrical desalination unit so that the electricity is used for production of water.

18. The integrated process as set forth in claim 14, wherein surplus electricity is efficiently used for production of water when demand for electricity reduces.

19. The integrated process as set forth in claim 14, wherein, since a single heat source is used for multiple purposes, heat utilization rate is increased in comparison to when electricity and water production processes are separated and heat sources are separately used for the respective processes.
